(19) United States
(12) Patent Application Publication
(10) Pub. No.: US 2013/0098829 A1
(43) Pub. Date: Apr. 25, 2013

(54) SPIRAL WOUND MEMBRANE ELEMENT AND PERMEATE CARRIER

(71) Applicants: Prasanna Rao DONTULA, Bangalore (IN); Yatin TAYALIA, Singapore (SG); Upen Jayant BHARWADA, Scottsdale, AZ (US); Jayaprakash Sandhala RADHAKRISHNAN, Bangalore (IN); Muralidhar PATNAM, Bangalore (IN)

(72) Inventors: Prasanna Rao DONTULA, Bangalore (IN); Yatin TAYALIA, Singapore (SG); Upen Jayant BHARWADA, Scottsdale, AZ (US); Jayaprakash Sandhala RADHAKRISHNAN, Bangalore (IN); Muralidhar PATNAM, Bangalore (IN)

(73) Assignee: GENERAL ELECTRIC COMPANY, Schenectady, NY (US)

(21) Appl. No.: 13/276,901

(22) Filed: Oct. 19, 2011

(51) Int. Cl. B01D 69/04; B32B 5/02; B01D 63/10

(52) U.S. Cl. 210/457; 428/166; 442/118

(57) ABSTRACT

A permeate carrier for a spiral wound membrane element has two or three layers, for example of tricot construction. The two outer, or only, layers resist movement of the membrane sheet into permeate channels in the permeate carrier. The total thickness of the permeate carrier sheet may be similar to the thickness of typical tricot permeate carrier sheets. The permeate carrier sheet may be coated to make its surfaces hydrophilic. The coating may be, for example, a cross-linked polyvinyl alcohol (PVA) or polyvinyl pyrrolidone (PVP). In the spiral wound element, a permeate carrier sheet may be wrapped in one or more layers around a central tube. Channels in the permeate carrier sheet are oriented helically relative to a longitudinal axis of the central tube.

### FIELD

This specification relates to spiral wound membrane elements and modules and to permeate carriers for spiral wound membrane elements and modules.

### BACKGROUND

A spiral wound membrane element is made by wrapping one or more membrane leaves and feed spacer sheets around a perforated central tube. The leaves have a permeate carrier sheet placed between two generally rectangular membrane sheets. The membrane sheets are sealed together along three edges. The fourth edge of the leaf is open and abuts the central tube. One or more layers of permeate carrier sheet may also be wrapped around the central tube to support the membrane leaf over the perforations in the central tube and to provide a flow path between the edge of the leaf and the central tube. Product water, also called permeate, passes through the membrane sheets and then flows through the permeate carrier sheet to reach the central tube.

The permeate carrier sheet may be a tricot fabric woven from epoxy or Melamine-coated polyester filaments. The tricot fabric is porous and forms a series of parallel ridges, which keep the membrane leaf from collapsing, separated by grooves on one side of the fabric. The grooves are oriented perpendicular to the central tube to provide less obstructed passages for permeate to flow inwards through the leaves to the central tube. A separate reinforcing or anti-bagging layer, made for example of felt or another non-woven or otherwise porous sheet material, may be placed between the membrane sheet and the tricot fabric to help keep the membrane sheet from being pressed into the grooves of the tricot.

U.S. Pat. No. 6,656,362 discloses various dimensions and materials for a permeate carrier sheet and reinforcing sheets that may be used with a high pressure spiral wound membrane. International Publication Number WO 03/101575 discloses permeate carrier materials intended to have low resistance to flow. U.S. Pat. Nos. 4,802,298 and 7,048,855 describe permeate carrier materials that are directly bonded to a membrane sheet. US Patent Application Publication No. 2004/0195164 A1 describes a spiral wound membrane element in which a) the total area of perforations in the central tube multiplied by the percentage of openings of one layer of a permeate carrier wrapped around the central tube is at least as much as b) the inner cross-sectional area of the central tube.

### INTRODUCTION TO THE INVENTION

A permeate carrier to be described in detail below comprises two or three layers. The two outer, or only, layers resist movement of the membrane sheet into permeate channels in the permeate carrier. The permeate channels may be located in a central layer, or on the insides of the outer layers, or both. All of the layers may be made from tricot sheets. To the extent that the permeate channels are not obstructed by the membrane sheet, the channels present less resistance to permeate flow. The membrane sheet may also withstand a higher pressure, or suffer less damage, since it is not stretched into the permeate channels. The total thickness of the permeate carrier sheet may be similar to the thickness of typical single layer tricot permeate carrier sheet, for example about 0.010 to 0.012 inches.

A permeate carrier sheet to be described below is coated to make its surfaces hydrophilic. The hydrophilic coating promotes water flow in the permeate channels. The coating may be, for example, a cross-linked polyvinyl alcohol (PVA), polyvinyl pyrrolidone (PVP) or other chemicals.

A permeate carrier sheet to be described below is wrapped in one or more layers around a central tube. Channels in the permeate carrier sheet are oriented helically relative to a longitudinal axis of the central tube. The helical orientation of the channels reduces a resistance to permeate flow along the length of the central tube from a channel in a permeate carrier sheet at the open edge of a membrane leaf to a perforation in the central tube.

The permeate carrier sheets may be used in a spiral wound membrane element or module. Any one or more of the permeate carrier sheets, or features of them, may be used in combination in the same spiral wound membrane element or module.

### BRIEF DESCRIPTION OF FIGURES

FIG. 1 is a cut-away perspective view of a spiral wound membrane element.

FIG. 2 is a cut-away perspective view of a spiral wound membrane module including the element of FIG. 1.

FIG. 3 is a photographs of the top layer of a permeate carrier sheet.

FIG. 4 is a photograph of the middle layer of a permeate carrier sheet.

FIG. 5 is a photograph of the bottom layer of a permeate carrier sheet.

FIG. 6 is a side view of a permeate carrier sheet wrapped around a central tube of a spiral wound membrane element.

### DETAILED DESCRIPTION

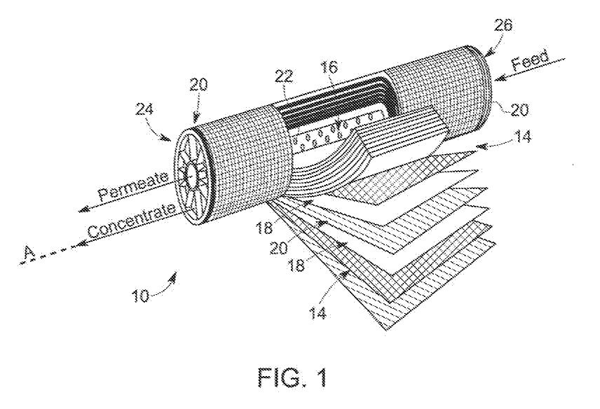

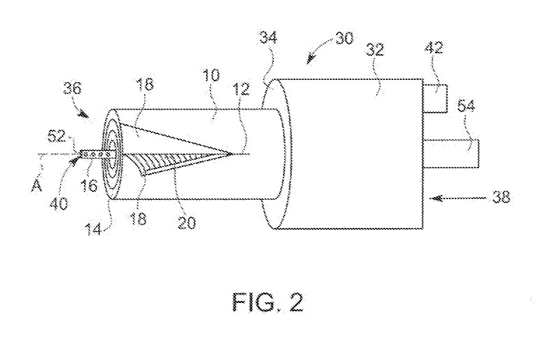

Referring to FIGS. 1 and 2, a spiral wound membrane element 10 is formed by wrapping one or more membrane leaves 12 and feed spacer sheets 14 around a perforated central tube 16. The membrane leaves 12 may also be called envelopes. The feed spacer sheets 14 may also be called brine channel spacers. The central tube 16 may also be called a core, a permeate tube or a produce water collection tube. The leaves 12 comprise two generally rectangular membrane sheets 18 surrounding a permeate carrier sheet 20. The edge of the membrane leaf 12 abutting the central tube 16 is open, but the other three edges of a leaf 12 are sealed, for example by an adhesive.

The membrane sheets 18 may have a separation layer cast onto a supporting or backing layer. The separation layer may be, for example, cellulose acetate, a polyamide, a thin film composite or other materials that may be formed into a separation membrane. The separation layer may have pores, for example, in the reverse osmosis, nanofiltration or ultrafiltration range. Filtered product water, also called permeate, passes through the membrane sheet while the passage of dissolved salts or suspended solids or other contaminants are rejected by the membrane sheet 18 depending on its pore size.

The permeate carrier 20 is in fluid contact with rows of small holes 22 in the central tube 16 through the open abutting edge of the membrane leaf 12. An additional permeate carrier sheet (not shown), which might or might not be the same material as the permeate carrier 20 in the membrane leaves 12, or an extension of the permeate carrier 20 of a first membrane leaf 12, may be wrapped around the central tube 16 in one or more layers before the first membrane leaf 12 is attached to the central tube 16. This initial wrap of permeate carrier 20 supports the membrane leaves 12 over the holes 22 and provides a path to conduct permeate water from the membrane leaves 12 to the holes 22 in the central tube 16. The holes 22 typically have a diameter of about 0.125 inches (3.2 mm) and conduct product water to the inside of the central tube 16.

Each leaf 12 is separated by a feed spacer sheet 14 that is also wound around the central tube 16. The feed spacer 14 is in fluid contact with both ends of the element 10 and it acts as a conduit for feed solution across the surface of the membrane sheets 18. The direction of feed flow is from the entrance end 24 to the concentrate end 26 parallel to the axis A of the central tube 16.

Referring to FIG. 2, a spiral wound membrane module 30 has an element 10 located inside of a pressure vessel 32. The pressure vessel 32 has a generally tubular body 34, an inlet end 36 and an outlet end 38. Feed water enters through an inlet (not shown) of the pressure vessel 32. The feed water travels through the feed spacer 14 of the element 10. A portion of the feed water that does not pass through the membrane sheets 18, which may be called retentate or reject water, leaves the pressure vessel 32 through a discharge tube 42. Product water, or permeate, collects in the inside of the central tube 16 and then typically travels in a direction from a first end 52 to a second end 54 of the central tube 16. The second end 54 of the last, or an only, element 10 may be sealed, may exit the pressure vessel 32 or may be connected to a fitting that exits the pressure vessel. The first end 52 of a first or only element 10 may be sealed, may exit the pressure vessel 32 or may be connected to a fitting that exits the pressure vessel 32. If there are multiple elements 10 in a pressure vessel 32, the second end 54 of an upstream element 10 is typically connected to the first end 52 of a downstream element. Feed water flows in series through the feed spacers 14 of multiple elements 10 in a pressure vessel. Peripheral seals may be provided between an outer wrap (not shown) of the element 10 and the inside of a pressure vessel 32 to prevent feed water from flowing past an element 10 without passing through its feed spacers 14.

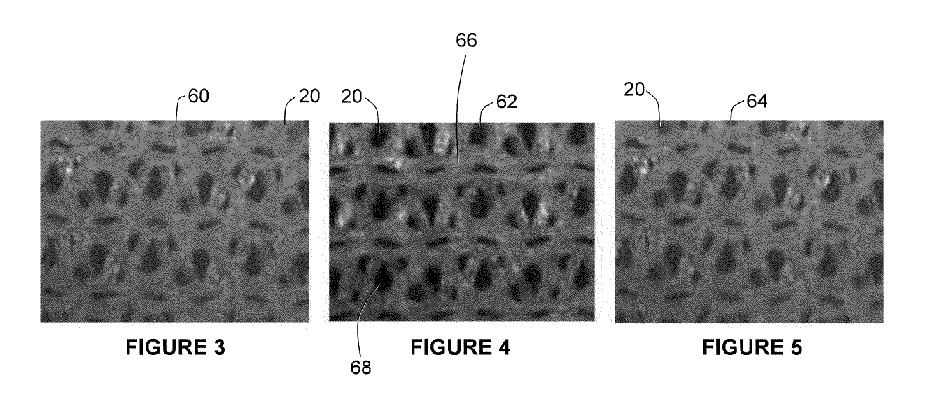

FIGS. 3, 4 and 5 show an upper layer 60, middle layer 62 and lower layer 64 of the permeate carrier 20. The middle layer 62 is optional. Each of the layers 60, 62, 64 are woven sheets. The layers 60, 62, 64 may be made of coated polymeric filaments woven into a tricot fabric. In a tricot fabric, the yarn zigzags vertically along columns of the knit resulting in a series of parallel raised wales 66 separating permeate channels 68 on a front side, alternately called the wale side, of the fabric. On the back side of the fabric, which may be called the course side, ribs are formed perpendicular to the raised wales 66, but the ribs are not as sharply defined as the raised wales 66 and are not as tall as the raised wales 66.

In FIGS. 3, 4 and 5, the upper layer 60 and lower layer 64 may be thinner than the middle layer 62, but all three layers 60, 62, 64 have raised wales 66. The layers 60, 62, 64 are placed on top of each other to form the permeate carrier 20. The upper layer 60 and the lower layer 64 are oriented in the permeate carrier such that their back sides are to the outside of the permeate carrier 20. The inner layer 62 may be oriented with its back side towards either the upper layer 60 or the lower layer 64. The raised wales 66 of all of the layers 60, 62, 64 are preferably placed over top of each other such that a line passing through the permeate carrier 20 perpendicular to the plane of the permeate carrier may pass through a raised wale 66 of each of the layers 60, 62, 64.

The inventors have observed that with a single layer tricot permeate carrier membrane 18 sagging or embossing on the side of the leaf 12 contacting the raise wales is more than on the other side of the leaf 12, particularly in seawater applications operating under high pressures. The pressure loss resulting from permeate flowing towards the central tube 16 varies with the third power of the height of the grooves between the raised wales. Sagging of the membrane sheet 18 into the grooves increases the pressure loss resulting from permeate flow. By orienting the upper layer 60 and lower layer 64 such that their course sides support the membrane sheet 18, sagging and pressure loss are reduced. However, the layers 60, 62, 64 are knit such that their total thickness is about the same as the thickness of a typical single layer permeate carrier (for example about 0.010 to 0.012 inches) and the total depth of the grooves 68 in the layers 60, 62, 64 is also about the same as the depth of the grooves in a typical single layer permeate carrier. The permeate carrier 20 described herein may therefore reduce pressure loss to the flow of permeate towards the central tube 16 by resisting sagging of the adjacent membrane sheet 18 into the permeate channels 68. This raises the net driving pressure (NDP) through the membrane sheet 18, thus raising the throughput, or rate of collection, of permeate.

The filaments in the permeate carrier 20 may be made of organic polymers such as nylon, polypropylene or polyester. Permeate carriers constructed of organic polymers are normally not water-wetting so water does not spontaneously spread on them. The permeate carrier 20 described herein is coated to make it hydrophilic to promote water flow in the permeate channels 68. The coating may be a cross-linked polyvinyl alcohol (PVA) of moderate molecular weight, polyvinyl pyrrolidone (PVP) or another similar chemical.

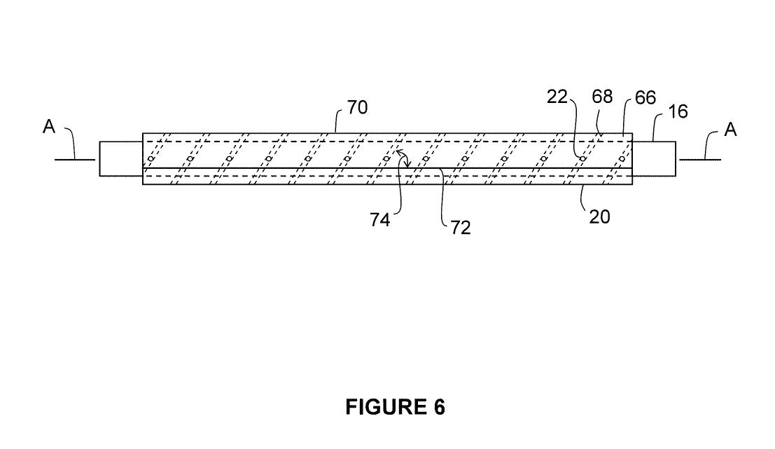

Referring to FIG. 6, a sheet of permeate carrier material 70 has been wrapped around a central tube 16 before membrane leaves 12 are attached to the central tube 16. The permeate carrier material 70 may circle the central tube one or more times, for example 2 to 4, to form an initial wrap. Permeate discharged from a leaf 12 passes through the initial wrap to reach a hole 22 in the central tube.

In a typical initial wrap, a permeate carrier is wrapped around a central tube with its raised wales following a circle around one point along the central longitudinal axis of the central tube. A tricot fabric, however, is anisotropic in its resistance to water flow. Water may flow easily perpendicular to the plane of the fabric, but flows less easily along permeate channels in the plane of the fabric and even less easily perpendicular to the wales in the plane of the fabric. In a typical initial wrap, the resistance to the permeate flowing in a radial direction towards the central tube may be low. However, at least some of the permeate is discharged from the leaves between holes in the central tube and must travel axially, along the length of the central tube, to reach a hole. Resistance to permeate flow in this axial direction is high. In addition, because tricot has porosity values in the range of 20-40%, a significant portion of the area of the holes is obstructed by the tricot.

In order to reduce the resistance to permeate flow in the axial direction, the permeate carrier material 70 has been cut at an angle relative to the direction of its permeate channels 68. For example, a trailing edge 72 of the permeate carrier material may be at an angle 74 to the permeate channels 68 of 80 degrees or less or 70 degrees or less. The angle 74 may be more than 45 degrees or more than 60 degrees. As a result, the permeate channels 68 are oriented helically with respect to the axis A of the central tube 16. In FIG. 6, the width of the wales 66 and permeate channels 68 have been greatly exaggerated to allow their helical path to be shown. The helical permeate channels 68 decrease the resistance to the axial flow of permeate towards a hole 22 in the central tube 16 by allowing permeate to move along the length of the central tube 16 as it moves inwards towards the central tube 16. The net driving pressure is raised by the same amount, thus raising the throughput of permeate.

The permeate carrier material 70 may be wound with either side contacting the central tube 16. However, it is preferable to have the wale side of the permeate carrier material 70 in contact with the outer surface of the central tube 16 to reduce obstruction of the holes 22. Further, the permeate carrier material 70 may be knit with a higher permeability or porosity than a typical permeate carrier used in a leaf 12 since the permeate carrier material 70 does not need to resist as much pressure.

The throughput or collection rate of permeate in a spiral wound element 10 is related to the pressure applied across the membrane. The pressure required to drive the permeate flow through the permeate channels 68 in the leaves 12, and from the edges of the leaves 12 towards the holes 22 of the central tube 16, reduces the net driving pressure for permeate flow through the membrane falls by the same amount. By using one or more of a permeate carrier 20 with multiple layers 60, 62, 64; a hydrophilic coating on the permeate carrier 20; and, a wrap around the central tube having helical permeate channels 86, the net driving pressure increases allowing for more permeate flow per element 10 at the same applied pressure.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A permeate carrier comprising,
a) a first layer of a tricot fabric having a course side and a wale side having raised wales; and,
b) a second layer of a tricot fabric having a course side and a wale side having raised wales,
wherein the raised wales of the first layer and the second layer are both oriented towards the inside of the permeate carrier.

2. A permeate carrier according to claim 1 further comprising a third layer of a tricot fabric having raised wales located between the first layer and the second layer.

3. A permeate carrier according to claim 1 wherein the raised wales of the first layer are located over the raised wales of the second layer.

4. A permeate carrier according to claim 2 wherein the raised wales of the third layer are located between the raised wales of the first layer and the raised wales of the second layer.

5. A permeate carrier according to claim 1 having a thickness of 0.012 inches or less.

6. A permeate carrier according to claim 1 wherein filaments of the first layer and the second layer are coated to make their surfaces hydrophilic.

7. A spiral wound membrane element having membrane leaves comprising a permeate carrier according to claim 1 wrapped around a central tube and an initial wrap of a second permeate carrier around the central tube, wherein the second permeate carrier comprises permeate channels which are oriented helically relative to a central longitudinal axis of the central tube.

8. A permeate carrier sheet comprising a hydrophilic coating.

9. The permeate carrier sheet of claim 8 wherein the hydrophilic coating comprises a cross-linked polyvinyl alcohol or polyvinyl pyrrolidone.

10. A spiral wound membrane element comprising,
a) a central tube; and,
b) a permeate carrier comprising permeate channels wrapped around the central tube,
wherein the permeate channels are oriented helically relative to a central longitudinal axis of the central tube.

11. The spiral wound membrane element of claim 10 wherein the permeate carrier comprises a tricot sheet and the permeate channels are defined by spaces between adjacent wales of the tricot sheet.

12. The spiral wound membrane of claim 10 wherein the permeate carrier is coated with a hydrophilic coating.
